(19) United States
(12) Patent Application Publication
(10) Pub. No.: US 2016/0341071 A1
(43) Pub. Date: Nov. 24, 2016

(54) COMPRESSED CHOPPED FIBER COMPOSITE FAN BLADE PLATFORM

(71) Applicant: UNITED TECHNOLOGIES CORPORATION, Farmington, CT (US)

(72) Inventors: Andrew G. Alarcon, Manchester, CT (US); Royce E. Tatton, Firth, ID (US); Barry M. Ford, Middletown, CT (US); Linda S. Li, Middlefield, CT (US); Matthew A. Turner, Wallingford, CT (US)

(73) Assignee: United Technologies Corporation, Farmington, CT (US)

(21) Appl. No.: 15/113,310

(22) PCT Filed: Dec. 15, 2014
(86) PCT No.: PCT/US2014/070278

§ 371 Date: Jul. 21, 2016

Related U.S. Application Data
(60) Provisional application No. 61/934,304, filed on Jan. 31, 2014.

(51) Int. Cl. F01D 25/00; B29C 70/12; F04D 29/32; F01D 11/00; F02K 3/06

(52) U.S. Cl. CPC F01D 25/005; F01D 11/008; F02K 3/06; F04D 29/325; B29C 70/12; F05D 2220/36; F05D 2300/603; F05D 2300/436; F05D 2300/434; F05D 2300/2102; F05D 2300/224; F05D 2300/123; F05D 2240/30; B29K 2105/12

(57) ABSTRACT

The present disclosure relates generally to the field of fan blade platforms for gas turbine engines. More specifically, the present disclosure relates to a compressed chopped fiber fan blade platform for a gas turbine engine.

### CROSS REFERENCE TO RELATED APPLICATION

The present application is related to, claims the priority benefit of U.S. Provisional Patent Application Ser. No. 61/934,304, filed Jan. 31, 2014. The contents of this application is hereby incorporated by reference in its entirety into this disclosure.

### TECHNICAL FIELD OF THE DISCLOSED EMBODIMENTS

The present disclosure is generally related to gas turbine engines and, more specifically, to a compressed chopped fiber composite fan blade platform for a gas turbine engine.

### BACKGROUND OF THE DISCLOSED EMBODIMENTS

Gas turbine engines (or combustion turbines) are built around a center body, holding a power core made up of a compressor, combustor and turbine, arranged in flow series with an upstream inlet and downstream exhaust. The compressor compresses air from the inlet, which is mixed with fuel in the combustor and ignited to generate hot combustion gas. The turbine extracts energy from the expanding combustion gas, and drives the compressor via a common shaft. Energy is delivered in the form of rotational energy in the shaft, reactive thrust from the exhaust, or both.

Generally, a gas turbine engine utilizes a fan section with fan blades having integrated fan blade platforms. In other configurations, the fan blade platforms are not integral with the fan blades. A fan section pulls air into the engine, and is surrounded by an outer fan casing which defines an air flow path. Generally, fan blade platforms are constructed of metallic alloys or Resin Transfer Molding (RTM) fabric. However, use of such metallic alloys or fabric is expensive and time consuming to machine.

Improvements in fan blade platforms are therefore needed in the art.

### SUMMARY OF THE DISCLOSED EMBODIMENTS

In one aspect, fan blade platform for a gas turbine engine is disclosed, the fan blade platform including: a fan blade platform surface top side and a fan blade platform surface bottom side. The platform top and bottom sides face opposing engine radial directions and the platform surfaces extend in engine axial and circumferential directions, wherein the fan blade platform top side and fan blade platform bottom side are composed of a compressed chopped fiber composite. The compressed chopped fiber composite includes a carbon-fiber, glass-fiber or Boron-fiber that is chopped into lengths of approximately 0.5-2.0″ long and pre-impregnated with a matrix material, such as an epoxy or other matrix resin system. The compressed chopped fiber composite includes a carbon epoxy. The compressed chopped fiber composite includes a polyether ether ketone (PEEK), polyetherimide (PEI), polyimide (PI), or other thermoplastic.

In another aspect, a gas turbine engine is disclosed, including: a plurality of fan blade platforms, each of the fan blade platforms are composed of a compressed chopped fiber composite. The compressed chopped fiber composite includes a carbon-fiber, glass-fiber or Boron-fiber that is chopped into lengths of approximately 0.5-2.0″ long and pre-impregnated with a matrix material, such as an epoxy or other matrix resin system. The compressed chopped fiber composite includes a carbon epoxy. The compressed chopped fiber composite includes a polyether ether ketone (PEEK), polyetherimide (PEI), polyimide (PI), or other thermoplastic. Each of the fan blade platforms further includes an airfoil operatively coupled to the fan blade platform.

Other embodiments are also disclosed.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a schematic cross-sectional view of a gas turbine engine;

FIG. 2 is a perspective view of a fan blade platform in an embodiment; and

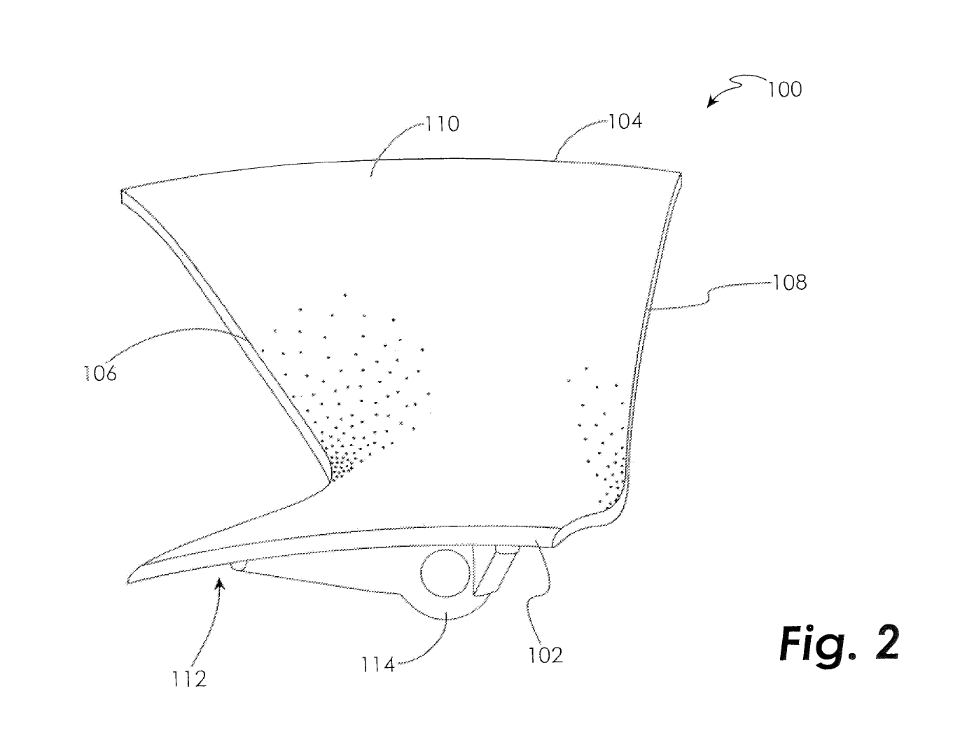

FIG. 3 is a bottom view of a fan blade platform in an embodiment.

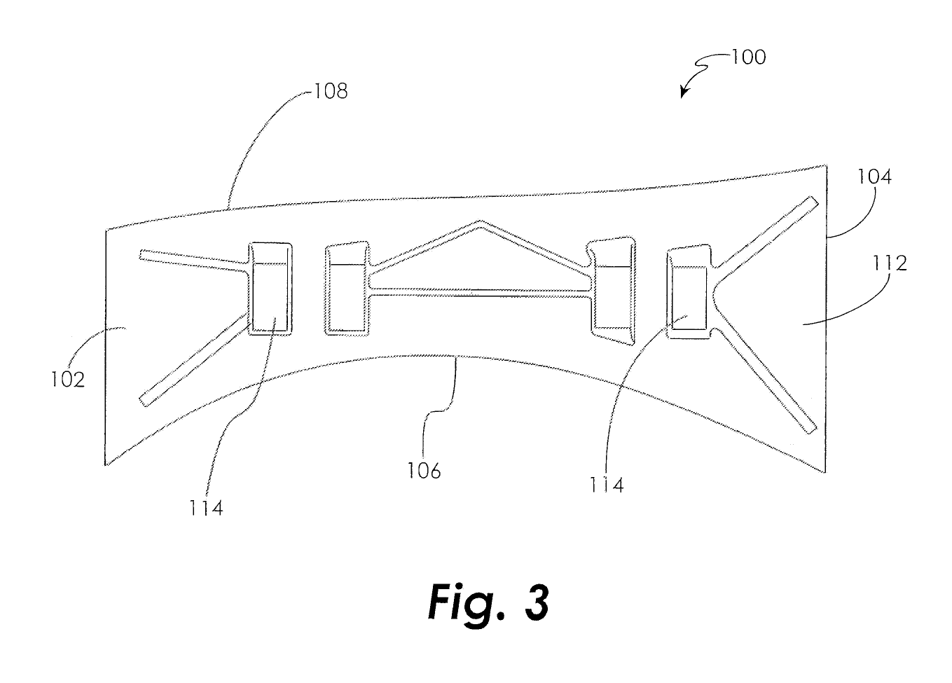

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

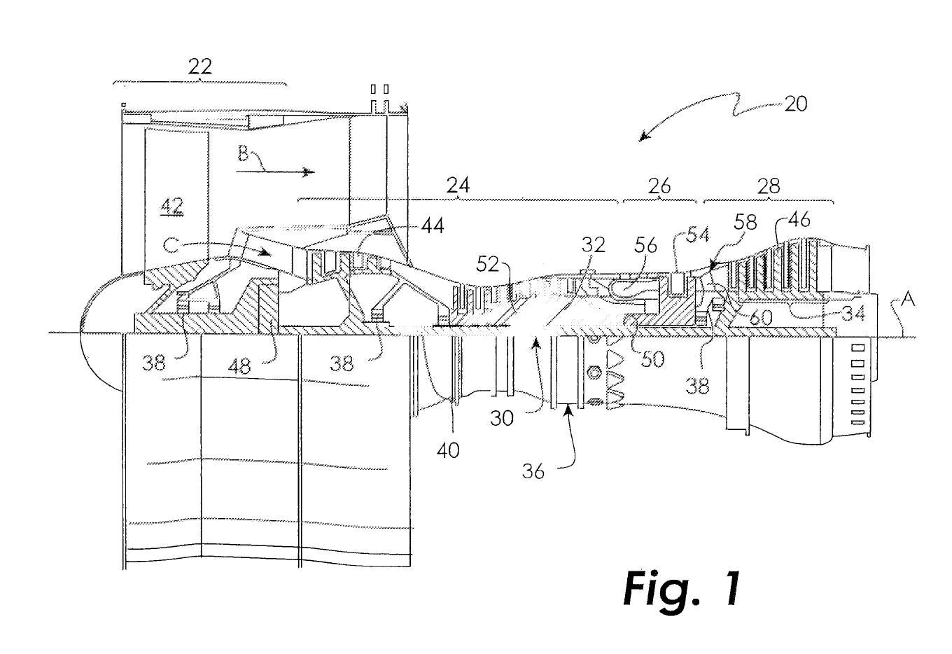

FIG. 1 schematically illustrates a typical architecture for a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. An engine static structure 36 is arranged generally between the high pressure turbine 54 and the low pressure turbine 46. The engine static structure 36 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded through the high pressure turbine 54 and low pressure turbine 46. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption (‘TSFC’)”—is the industry standard parameter of 1 bm of fuel being burned divided by 1 bf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft./sec divided by an industry standard temperature correction of [(Tram ° R)/(518.7° R)]^{0.5}. The “Low corrected fan tip speed” as disclosed herein according to one non-limiting embodiment is less than about 1150 ft./second.

In one aspect, fan blade platform for a gas turbine engine is disclosed, the fan blade platform including: a fan blade platform surface top side and a fan blade platform surface bottom side. The platform top and bottom sides face opposing engine radial directions and the platform surfaces extend in engine axial and circumferential directions, wherein the fan blade platform top side and fan blade platform bottom side are composed of a compressed chopped fiber composite. For example, in some embodiments the compressed chopped fiber composite comprises a carbon-fiber, glass-fiber or Boron-fiber that is chopped into lengths of approximately 0.5-2.0″ long and pre-impregnated with a matrix material, such as an epoxy or other matrix resin system. In one embodiment, the compressed chopped fiber composite includes a carbon epoxy, for example the Hexcel® HexMC® carbon fiber epoxy resin molding material. In other embodiments, the compressed chopped fiber composite includes a polyether ether ketone (PEEK), polyetherimide (PEI), polyimide (PI), or other thermoplastic, to name just a few non-limiting examples.

Constructing the plurality of fan blade platforms 100 from a compressed chopped fiber composite allows for greater design flexibility to construct complex shapes and easily alter cross-section designs as compressed chopped fiber composite is less sensitive to defects than other materials. Additionally, compressed chopped fiber composite may be a lighter material, compared to aluminum, thus, providing a lighter and more cost effective fan blade platform 100.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A fan blade platform comprising:
a fan blade platform surface top side and a fan blade platform surface bottom side, the platform top and bottom sides facing opposing engine radial directions and the platform surfaces extending in engine axial and circumferential directions;
wherein fan blade platform surface top side and a fan blade platform surface bottom side are composed of a compressed chopped fiber composite.

2. The fan blade platform of claim 1, wherein the compressed chopped fiber composite comprises a material selected from the group consisting of: carbon-fiber, glass-fiber or Boron-fiber.

3. The fan blade platform of claim 1, wherein the compressed chopped fiber composite comprises a fiber that is chopped into lengths of approximately 0.5″ to approximately 2″ long.

4. The fan blade platform of claim 1, wherein the compressed chopped fiber composite comprises a fiber that is pre-impregnated with a matrix material.

5. The fan blade platform of claim 4, wherein the matrix material is selected from the group consisting of epoxy and resin.

6. The fan blade platform of claim 5, wherein the epoxy comprises a carbon epoxy.

7. The fan blade platform of claim 1, wherein the compressed chopped fiber composite comprises a material selected from the group consisting of: polyether ether ketone (PEEK), polyetherimide (PEI), and polyimide (PI).

8. The fan blade platform of claim 1, further comprising at least one attachment member disposed on the fan blade platform bottom side, wherein the at least one attachment member is composed of a compressed chopped fiber composite.

9. A gas turbine engine comprising:
a plurality of fan blade platforms, each fan blade platform composed of a compressed chopped fiber composite.

10. The gas turbine engine of claim 9, wherein the compressed chopped fiber composite comprises a material selected from the group consisting of: carbon-fiber, glass-fiber or Boron-fiber.

11. The gas turbine engine of claim 9, wherein the compressed chopped fiber composite comprises a fiber that is chopped into lengths of approximately 0.5″ to approximately 2″ long.

12. The gas turbine engine of claim 9, wherein the compressed chopped fiber composite comprises a fiber that is pre-impregnated with a matrix material.

13. The gas turbine engine of claim 12, wherein the matrix material is selected from the group consisting of epoxy and resin.

14. The gas turbine engine of claim 13, wherein the epoxy comprises a carbon epoxy.

15. The gas turbine engine of claim 9, wherein the compressed chopped fiber composite comprises a material selected from the group consisting of: polyether ether ketone (PEEK), polyetherimide (PEI), and polyimide (PI).

16. The gas turbine engine of claim 9, wherein each fan blade platform comprises:
a fan blade platform surface top side and a fan blade platform surface bottom side, the platform top and bottom sides facing opposing engine radial directions and the platform surfaces extending in engine axial and circumferential directions.

17. The gas turbine engine of claim 16, wherein each fan blade platform further comprises an air foil operably coupled to each fan blade platform surface top side.

18. The gas turbine engine of claim 17, wherein each fan blade platform further comprises an attachment member disposed on the fan blade platform bottom side, wherein the at least one attachment member is composed of a compressed chopped fiber composite.
